(19) United States
(12) Patent Application Publication
(10) Pub. No.: US 2015/0068877 A1
(43) Pub. Date: Mar. 12, 2015

(54) ARRANGEMENT OF VACUUM SWITCHING TUBES IN A LOAD TRANSFER SWITCH

(71) Applicant: MASCHINENFABRIK REINHAUSEN GMBH, Regensburg (DE)

(72) Inventors: Klaus Hoepfl, Maxhuette-Haidhof (DE); Silke Wrede, Zeitlarn (DE); Christian Kotz, Schorndorf (DE)

(21) Appl. No.: 14/389,099

(22) PCT Filed: Apr. 8, 2013
(86) PCT No.: PCT/EP2013/057276

§ 371 Date: Sep. 29, 2014

(30) Foreign Application Priority Data
May 22, 2012 (DE) 10 2012 104 378.7

(51) Int. Cl. H01H 9/00

(52) U.S. Cl. CPC H01H 9/0027; H01H 9/0038
USPC 200/11 TC

(57) ABSTRACT

Arrangement of vacuum switching tubes (3, 3a, 3b) in a load transfer switch (1), wherein in each case one cam controller (5) comprising a control cam (7) and a lever bearing (10) for operating a moving contact (13) is associated with in each case one of the vacuum switching tubes (3, 3a, 3b), wherein at least one camshaft (15a, 15b) is arranged axially parallel to a drive shaft (11) and can be driven by means of said drive shaft, and wherein each axis (A) of the moving contact (13) of each vacuum switching tube (3, 3a, 3b) is arranged perpendicular to an axis (E) of the respective camshaft (15a, 15b).

The present invention relates to an arrangement of vacuum interrupters in a load changeover switch. A respective cam controller consisting of a control cam and a lever bearing is, for actuation of a movable contact, associated with each of the vacuum interrupters.

Load changeover switches of the kind described in the introduction are incorporated in on-load tap changers and serve for successive, rapid and uninterrupted switching over from the connected winding tap to the new, preselected winding tap. The entire on-load tap changer is actuated by a motor drive for the changeover. A rotating drive shaft continuously moves a selector and at the same time a force-storage unit of the load changeover switch is loaded. The selector serves for power-free selection of the respective new winding tap of the transformer that is to be switched to.

In the case of the described load changeover the load changeover switch executes a specific switching sequence, i.e. different switch contacts and resistance contacts are actuated in a specific succession in time in succession or with an overlap. The switch contacts in that case serve for direct connection of the respective winding tap with the load diverter and the resistance contacts for temporary connection, i.e. bridging over by means of one or more switch-over resistances. Vacuum interrupters are advantageously used as switching elements for the load changeover. This is due to the fact the use of vacuum interrupters for the load changeover prevents formation of arcs in the oil and thus oil contamination of the oil in the load changeover switch.

A load changeover switch of that kind is disclosed in German published specification DE 10 2009 043 171 A1. Here, the load changeover switch carries a drive shaft with at least one cam disc. The cam disc has several control cams, wherein two control cams arranged at the cam disc at the end have a profile, which departs from a circular shape, in the form of lobes at each of which a respective roller, which is connected by way of a rocker with a vacuum interrupter and the profile contour of which scans the respective control cam, is guided with maintained contact.

The invention has the object of creating a space-saving and simple arrangement of vacuum interrupters in a load changeover switch that ensures a rapid and individually adaptable load changeover.

This object is fulfilled by an arrangement of vacuum interrupters in a load changeover switch comprising the features of claim 1.

The arrangement in accordance with the invention of vacuum interrupters in a load changeover switch comprises a respective cam controller that comprises a control cam and a lever bearing. Each control cam is, for actuation of a movable contact, associated with a respective one of the vacuum interrupters. The arrangement according to the invention is distinguished by the fact that at least one camshaft is arranged axially parallel to a drive shaft and is drivable thereby. In that case, each axis of the movable contact of each vacuum interrupter is perpendicular to an axis of the respective camshaft.

According to one form of embodiment the at least one camshaft and the drive shaft are so arranged that the drive of the at least one camshaft takes place by way of a gear that is seated at an upper end of the drive shaft, and a gear that co-operates therewith, of the at least one camshaft.

It will be obvious to the expert that other mechanical transmissions are also conceivable, since various machine elements for transmission between two arrangements, i.e. pairing of two gears, are disclosed in the prior art. It is additionally conceivable for the gear of the drive shaft to be seated not on an end of the drive shaft. The gear can be seated at any desired position along the drive shaft. The sole constructional precondition is that the gears of the camshafts have to be in operative connection with the gear on the drive shaft.

In order to realize the above-described actuation of a movable contact of a vacuum interrupter each camshaft has at least one control cam. Thus, the at least one camshaft, which is driven by the drive shaft, with at least one control cam rotates about its own axis, in particular in such a manner that the at least one control cam actuates the lever bearing. The lever bearing comprises a compression spring and a lever, such as, for example, a rocker switch, i.e. the control cam actuations the lever in such a way that, for example, via a rocking movement of the lever the compression spring mechanically coupled therewith actuations (opens) the movable contact in opposite direction of a vacuum interrupter.

In a first form of embodiment the vacuum interrupters are arranged along a line, i.e. a camshaft has several control cams, wherein each control cam actuates, via a lever bearing, a movable contact of a respective one of the vacuum interrupters. Thus, for example, a camshaft with three control cams can actuate three vacuum interrupters. In that case, the orientation of the control cams at the camshaft can also be differently designed. Thus, control cams of the same orientation can actuate simultaneously, and control cams with offset orientation at a cam shaft can actuate with an offset, the vacuum interrupters by the same stroke or different stroke.

In a second form of embodiment the vacuum interrupters are arranged in the form of a matrix, i.e. at least two camshafts each actuate at least one respective vacuum interrupter. For preference the at least one two camshafts have a plurality of control cams, so that even in the form of a matrix several vacuum interrupters are arranged along a line. A fast and individually adaptable load changeover is thus possible by virtue of the plurality of actuatable vacuum interrupters.

A further form of embodiment provides that a respective first vacuum interrupter and a respective second vacuum interrupter are connected together in such a manner that the two movable contacts of the first vacuum interrupter and the second vacuum interrupter are oriented oppositely to one another, wherein the axis of the movable contact of the first vacuum interrupter is perpendicular to the axis of the at least one first camshaft and the axis of the movable contact of the second vacuum interrupter is perpendicular to the axis of the at least one second camshaft of the movable contact.

Thus, one form of embodiment provides that arranged between the first vacuum interrupter and the second vacuum interrupter is a mounting plate with which the first and second vacuum interrupters are connected by material bond. A second form of embodiment provides that the first vacuum interrupter and the second vacuum interrupter are directly connected together by material bond. For preference, the first vacuum interrupter mounting plate or the second vacuum interrupter are glued together. It is obvious that also any form of connection known from the prior art can be used for the invention.

In a preferred form of embodiment the first vacuum interrupters and the second vacuum interrupters are arranged in the form of a matrix. In addition, at least two first camshafts and at least two second camshafts are provided, wherein the axes of the respective camshafts are arranged parallel to a common drive shaft.

An advantage in the case of the arrangement in accordance with the invention of vacuum interrupters at a load changeover switch consists in that by virtue of a matrix arrangement of vacuum interrupters a space-saving and simple arrangement for a load changeover switch is created.

A further advantage of the arrangement according to the invention is that several vacuum interrupters can be actuated simultaneously and/or with an offset and with the same stroke or different strokes. A rapid and individually adaptable load changeover is thus possible.

The invention and the advantages thereof are described in more detail in the following with reference to the accompanying drawings, in which:

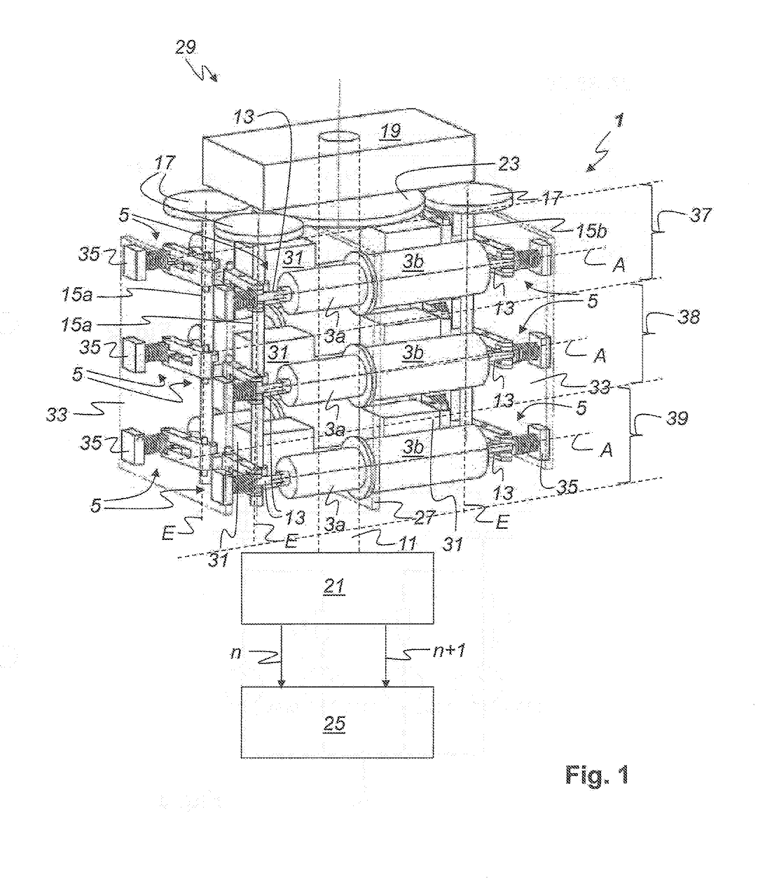

FIG. 1 shows a perspective view of a form of embodiment according to the invention of the arrangement of vacuum interrupters in the form of a matrix at a load changeover switch;

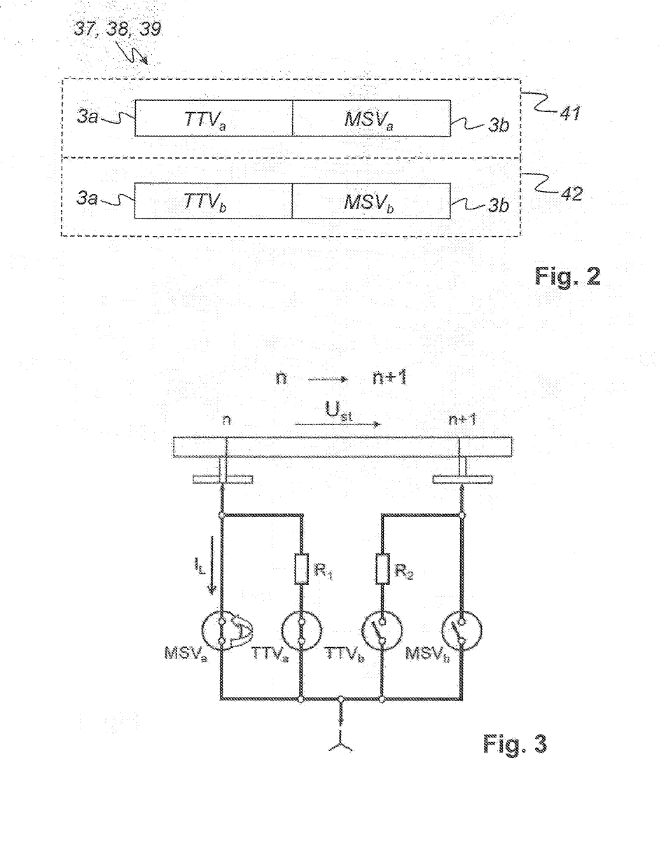

FIG. 2 shows a schematic illustration of one of three phases of the load changeover switch;

FIG. 3 shows a circuit diagram of a switching course that four vacuum interrupters run through in a respective phase according to FIG. 2;

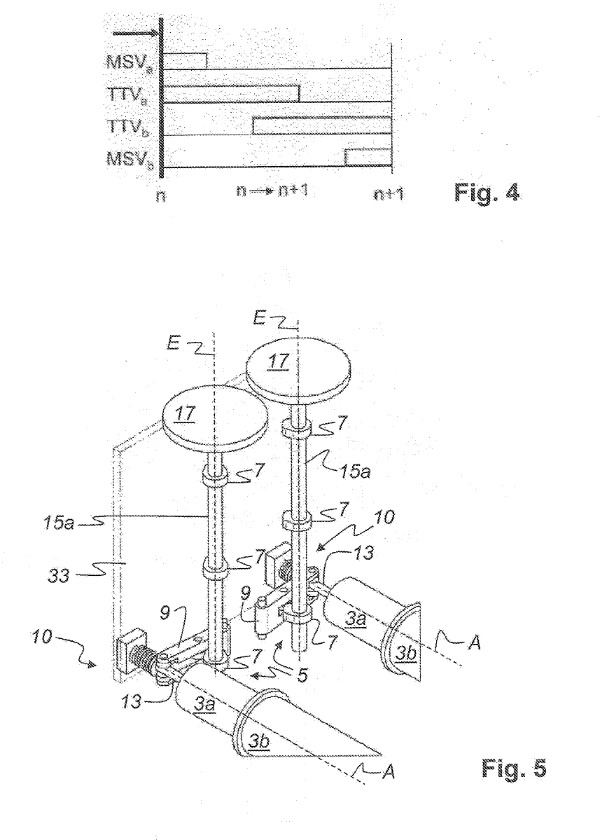

FIG. 4 shows the switching sequence of the switching course according to FIG. 3;

FIG. 5 shows a perspective view of a cam controller for actuation of a movable contact of each vacuum interrupter according to FIG. 1;

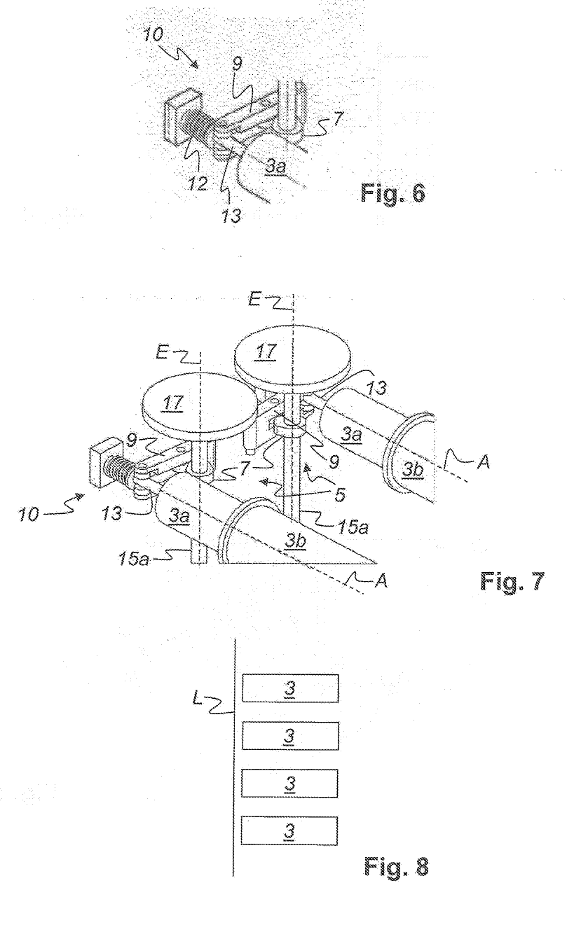

FIG. 6 shows an enlarged perspective view of a lever bearing of the cam controller according to FIG. 5;

FIG. 7 shows a further perspective view of the cam controller according to FIG. 1 and FIG. 5; and

FIG. 8 shows a schematic illustration of one possibility of the arrangement of vacuum interrupters.

Identical reference numerals are used in the figures for the same or equivalent elements of the invention. Moreover, for the sake of clarity there is illustration in the individual FIGS. of only reference numerals that are required for description of the respective figure.

FIG. 1 shows a perspective view of a preferred form of embodiment of the arrangement according to the invention of twelve vacuum interrupters 3a, 3b in a load changeover switch 1. The load changeover switch 1, which is part of an on-load tap changer 29, effects changeover from the connected winding tap n to the respective preselected winding tap n+1. The entire on-load tap changer 29 is actuated by a motor drive for the changeover. A rotating drive shaft 11 continuously moves a selector 21 and at the same time a force-storage unit 19 of the load changeover switch 1 is loaded. The selector 21 serves for power-free selection of the respective new winding tap of a transformer 25 that is to be switched to. When the force-storage unit 19 is completely loaded it is unlatched, abruptly releases its energy and actuates the load changeover switch 1 in the millisecond range by way of the drive shaft 11.

As already described, the load changeover switch 1 comprises twelve vacuum interrupters 3a, 3b, wherein a respective cam controller 5, comprising a control cam 7 and a lever bearing 10 (see, for that purpose, FIGS. 5, 6 and 7) is, for actuation of a movable contact 13, associated with a respective one of the first and second vacuum interrupters 3a, 3b.

According to the invention the twelve vacuum interrupters 3a, 3b are arranged in the form of a matrix. Since the load changeover switch 1 has three phases 37, 38, 39 each of the three phases 37, 38, 39 has four vacuum interrupters 3a, 3b. The four vacuum interrupters 3a, 3b of each phase 37, 38, 39 are divided into two first vacuum interrupters 3a and two second vacuum interrupters 3b, wherein in each instance a first vacuum interrupter 3a and a second vacuum interrupter 3b of each phase 37, 38, 39 form a respective first load branch 41 and second load branch 42. This is schematically illustrated in FIG. 2.

Disposed in the first load branch 41 is a second vacuum interrupter 3b, which acts as a main contact MSVa, as well as a first vacuum interrupter 3a that acts as resistance contact TTVa. The second load branch 42 analogously has a second vacuum interrupter 3b acting as main contact MSVb and a first vacuum interrupter 3a acting as resistance contact TTVb.

FIG. 3 shows a circuit diagram of a switching course that four vacuum interrupters 3a, 3b run through in a respective phase 37, 38, 39 according to FIG. 2.

FIG. 4 shows the switching sequence of the switching course in the case of changeover from the winding tap n to the winding tap n+1. The initial position, in which the tap is connected, corresponds with the setting, which is illustrated in FIG. 3, of the individual switching elements. The changeover takes place in the following steps: MSVa opens, TTVb closes, TTVa opens and MSVb closes. The changeover is concluded.

The load changeover switch 1 according to FIG. 1 thus has, in total, six second vacuum interrupters 3b acting as main contact MSV and six first vacuum interrupters 3a acting as resistance contact TTV. In addition, two first camshafts 15a and two second camshafts 15b (in this perspective view only one second camshaft 15b is visible) are arranged axially parallel to the drive shaft 11 and are drivable thereby. In that case, an axis A of each movable contact 13 of each first and second vacuum interrupter 3a, 3b is perpendicular to an axis E of the first and second camshafts 15a, 15b. However, it is also conceivable for further forms of embodiment to have a lesser or greater number than six first and second vacuum interrupters 3a, 3b and two first and second camshafts 15a, 15b.

In the form of embodiment shown here, in particular, in each instance the first vacuum interrupter 3a and the second vacuum interrupter 3b are so connected together that the two respectively associated movable contacts 13 of the first vacuum interrupter 3a or second vacuum interrupter 3b are oriented oppositely, wherein the axes A of the movable contact 13 of the first vacuum interrupters 3a are perpendicular to the axis E of the two camshafts 15a and the axes A of the movable contact 13 of the second vacuum interrupters 3b are perpendicular to the axis E of the two second camshafts 15b of the movable contact 13.

For connection of each first vacuum interrupter 3a with a second vacuum interrupter 3b, also termed tandem interrupters, a mounting plate 27 is here arranged between the first and second vacuum interrupters 3a, 3b. In that case, each first and second vacuum interrupter 3a, 3b is connected by a material-coupling connection, such as, for example, gluing, with the mounting plate 27.

The arrangement and drivability of the first and second camshaft 15a, 15b by way of the drive shaft 11 is in that case preferably designed in such a manner that in accordance with the form of embodiment illustrated here a gear 23 is arranged at an upper end of the drive shaft 11 and a respective gear 17 is arranged at an upper end of each of the first and second camshafts 15a, 15b, so that each gear 17 of the first and second camshafts 15a, 15b co-operates with the gear 23 of the drive shaft 11.

In order to realize actuation of a movable contact 13 of the first and second vacuum interrupters 3a, 3b, each first and second camshaft 15a, 15b has at least one control cam 7 (see, for that purpose, FIG. 5). B y means of the drive shaft 11 the first and second camshafts 15a, 15b rotate about the individual axis E and thus entrain the at least one control cam 7. The at least one control cam 7 thus actuates a respective lever bearing 10 (see, for that purpose, the description with respect to FIG. 5 and FIG. 6).

Moreover, the arrangement according to the invention of first and second vacuum interrupters 3a, 3b for a load changeover switch 1 provides further elements such as, for example, switch-over resistances 31 for the first and second vacuum interrupters 3a, 3b, external mounting plates 33 for the arrangement of the elements in a load changeover switch 1, and spring mountings 35 for compression springs 12 (see FIG. 6), which overall are self-explanatory, for which reason a more detailed description of these elements was dispensed with here.

FIG. 5 shows a perspective view of a cam controller 5 for actuation of a movable contact 13 of in each instance the one of the two first vacuum interrupters 3a according to FIG. 1. Each cam controller comprises a first vacuum interrupter 3a, a lever bearing 10 and a control cam 7. In the form of embodiment shown here each first camshaft 15a has three control cams 7. Other forms of embodiment can also provide a greater a lesser number of control cams 7 at a cam shaft 15a, 15b. Each lever bearing 10, illustrated to enlarged scale in FIG. 6, comprises a compression spring 12 and a rocker switch as a lever 9. The control cam 7 rotatable with the first camshaft 15a actuates the lever 9 of the lever bearing 10 so that by way of a rocking movement of the lever 9 the compression spring 12 mechanically coupled therewith actuates the movable contact 13 in the direction of the first vacuum interrupters 3a.

As already described in the form of embodiment of FIG. 1 the first vacuum interrupters 3a and the second vacuum interrupters 3b are connected together by way of a mounting plate 27. In the form of embodiment shown here the first vacuum interrupters 3a and the second vacuum interrupters 3b are connected together by material couple.

FIG. 7 shows a further perspective view of the cam controller 5 according to FIGS. 1 and 2. All elements are already described in FIGS. 1 and 5.

FIG. 8 shows a view of four vacuum interrupters 3 that are arranged along a line L. Thus, a camshaft 15a or 15b (see, for that purpose, FIG. 1) has four control cams 7 (see, for that purpose, for example FIG. 5), wherein each control cam 7 actuates by way a lever bearing 10 (see FIG. 6) a movable contact 13 (see, similarly, FIG. 1 or 5) of a respective one of the four vacuum interrupters 3. Thus, one camshaft 15a or 15b with four control cams 7 can actuate four vacuum interrupters 3. In that case, the orientation of the control cams 7 at the camshaft 15a or 15b can also be designed to be different. Thus, control cams 7 with the same orientation can actuate simultaneously, and control cams 7 oriented at a camshaft 15a or 15b with an offset, can actuate with an offset the vacuum interrupters 15a or 15b by the same stroke or different strokes.

The invention was described with reference to preferred forms of embodiment. However, it is obvious to any expert that modifications and changes can be undertaken without in that case departing from the scope of protection of the appended claims. The embodiments explained beforehand serve merely for description of the claimed teaching, but do not restrict this to the embodiments.

Reference numeral list:

| | |
|---|---|
| 1 | load changeover switch |
| 3 | vacuum interrupter |
| 3a | first vacuum interrupter |
| 3b | second vacuum interrupter |
| 5 | cam controller |
| 7 | control cam |
| 9 | lever |
| 10 | lever bearing |
| 11 | drive shaft |
| 12 | compression spring |
| 13 | movable contact |
| 15a | first camshaft |
| 15b | second camshaft |
| 17 | gear |
| 19 | force-storage unit |
| 21 | selector |
| 23 | gear |
| 25 | transformer |
| 27 | mounting plate for vacuum |
| | interrupter |
| 29 | on-load tap changer |
| 31 | switch-over resistance |
| 33 | external mounting plate |
| 35 | spring mount |
| 37 | first phase |
| 38 | second phase |
| 39 | third phase |
| 41 | first load branch |
| 42 | second load branch |
| A | axis of the movable contact |
| E | axis of the camshaft |
| L | line |
| n | connecting winding tap |
| n + 1 | preselectable winding tap |

1. In an arrangement of vacuum interrupters in a load changeover switch where a respective cam controller comprising a control cam and lever bearing for actuating a movable contact is associated with each of the vacuum interrupters the improvement wherein:
at least one camshaft is arranged axially parallel to a drive shaft and is drivable thereby and
each axis of the movable contact of each vacuum interrupter is perpendicular to an axis of the respective camshaft.

2. The arrangement according to claim 1, wherein a gear of the at least one camshaft co-operates with a gear of the drive shaft.

3. The arrangement according to claim 1, wherein each camshaft comprises at least one control cam.

4. The arrangement according to claim 1, wherein the vacuum interrupters are arranged along a line.

5. The arrangement according to claim 1, wherein the vacuum interrupters are arrayed in a matrix.

6. The arrangement according to claim 1, wherein in each instance a first vacuum interrupter and a second vacuum interrupter are so connected together that the two movable contacts of the first vacuum interrupter and the second vacuum interrupter are oriented oppositely to one another, wherein the axis of the movable contact of the first vacuum interrupter is perpendicular to the axis of at least one first camshaft and the axis of the movable contact of the second vacuum to interrupter is perpendicular to the axis of at least one second cam shaft of the movable contact.

7. The arrangement according to claim 6, wherein arranged between the first vacuum interrupter and the second vacuum interrupter is a mounting plate, with which the first and second vacuum interrupters are connected by material couple.

8. The arrangement according to claim 6, wherein the first vacuum interrupter and the second vacuum interrupter are connected together by material couple.

9. The arrangement according to claim 6, wherein the first vacuum interrupters and the second vacuum interrupters are arranged in the form of a matrix and that at least two first camshafts and at least two second camshafts are provided, wherein the axes of the respective camshafts are arranged parallel to a common drive shaft.
